(19) United States
(12) Patent Application Publication
(10) Pub. No.: US 2017/0273497 A1
(43) Pub. Date: Sep. 28, 2017

(54) BEVERAGE PREPARATION APPARATUS

(71) Applicant: Sharp Kabushiki Kaisha, Sakai City, Osaka (JP)

(72) Inventors: Naozumi SUGIMOTO, Sakai City, Osaka (JP); Akihiro YOSHIDOME, Sakai City, Osaka (JP); Hidekazu SHIMA, Sakai City, Osaka (JP)

(73) Assignee: Sharp Kabushiki Kaisha, Sakai City, Osaka (JP)

(21) Appl. No.: 15/505,860

(22) PCT Filed: Jan. 29, 2016
(86) PCT No.: PCT/JP2016/052701

§ 371 Date: Feb. 22, 2017

(30) Foreign Application Priority Data
Mar. 2, 2015 (JP) 2015-040450

(51) Int. Cl. A47J 31/00; A47J 31/46; A47J 31/40; A23F 3/18; A47J 31/14

(52) U.S. Cl. CPC A47J 31/002; A23F 3/18; A47J 31/14; A47J 31/40; A47J 31/467; A47J 31/00

(57) ABSTRACT

A beverage preparation apparatus includes a liquid storage tank, a liquid supply path having one end serving as an introduction port and the other end serving as a supply port, a heating device for heating a liquid in the liquid supply path, a tank to which the liquid heated by the heating device is supplied through the supply port, an air passage path including an air inlet and an air outlet and sending air into the tank, and a fan arranged in the air passage path. The air passage path is provided to include a portion extending from a lower side toward an upper side along a peripheral surface of the liquid storage tank.

### TECHNICAL FIELD

The present invention relates to a beverage preparation apparatus for preparing a beverage by using a liquid and powders obtained by grating an object to be grated.

### BACKGROUND ART

Various types of beverage preparation apparatuses capable of cooling a produced beverage to a prescribed temperature have conventionally been developed. For example, Japanese Utility Model Laying-Open No. 4-044840 (PTD 1) discloses a beverage preparation apparatus of such a type.

Various types of electric pots capable of cooling boiled water to a prescribed temperature have also been developed, although they are not beverage preparation apparatuses. For example, Japanese Patent Laying-Open No. 6-269354 (PTD 2) discloses an electric pot of such a type.

The beverage preparation apparatus disclosed in PTD 1 cools a beverage at a high temperature extracted into a container to a temperature around a room temperature by cooling the container with a fan provided in a main body.

In the electric pot disclosed in PTD 2, hot water boiled in a container is circulated to any one of a first heat exchanger and a second heat exchanger by using an electric pump. By cooling a heat radiation fin to which the first heat exchanger and the second heat exchanger are attached with the fan, heat of hot water is radiated to the outside through the heat radiation fin and hot water in the container is cooled to a prescribed temperature.

### CITATION LIST

### Patent Document

### PTD 1: Japanese Utility Model Laying-Open No. 4-044840

### PTD 2: Japanese Patent Laying-Open No. 6-269354

### PTD 3: Japanese Patent Laying-Open No. 2005-199242

### SUMMARY OF INVENTION

### Technical Problem

Since the beverage preparation apparatus described in PTD 1 cools a beverage in the container indirectly by cooling the container, cooling efficiency is poor in an example in which a container low in thermal conductivity is employed, and such a beverage preparation apparatus is unfavorable.

Since the electric pot described in PTD 2 requires a heat exchanger, a pump, and a fan for circulating hot water to the heat exchanger, an apparatus is large-scale and cost for manufacturing also increases. In any case, sensible heat of hot water is removed for lowering a temperature, and a temperature of hot water is not lowered by removing great latent heat of evaporation of hot water.

The present invention was made in view of the problems as above, and an object of the present invention is to provide a beverage preparation apparatus simplified in construction which is capable of suppressing increase in temperature of cooling air and suppressing lowering in efficiency in cooling.

### Solution to Problem

A beverage preparation apparatus based on the present invention includes a liquid storage tank storing a liquid, a liquid supply path having one end connected to the liquid storage tank to serve as an introduction port introducing the liquid stored in the liquid storage tank to the inside and the other end serving as a supply port supplying the liquid to the outside, a heating device provided in a region intermediate in the liquid supply path, for heating the liquid in the liquid supply path, a tank to which the liquid heated by the heating device is supplied through the supply port, an air passage path including an air inlet and an air outlet for sending air into the tank, and a fan arranged in the air passage path. The air passage path is provided to include a portion extending from a lower side toward an upper side along a peripheral surface of the liquid storage tank.

In the beverage preparation apparatus based on the present invention, the air inlet is preferably located below the air outlet.

In the beverage preparation apparatus based on the present invention, the liquid supply path is preferably provided to include a portion which once extends downward from the liquid storage tank from the introduction port and thereafter extends upward, and the heating device is preferably provided below the liquid storage tank. The air passage path is preferably located at a distance from the heating device by positioning a center of the air inlet above an upper end of the heating device.

In the beverage preparation apparatus based on the present invention, the introduction port may be provided on a front side of a virtual line which passes laterally through a center of the liquid supply path in a front-rear direction, and the portion of the air passage path extending from the lower side toward the upper side along the peripheral surface of the liquid storage tank may be provided on a rear side of the virtual line.

In the beverage preparation apparatus based on the present invention, the air passage path is preferably provided to include a portion adjacent to the liquid supply path downstream of a region where the heating device is provided. In this case, in the adjacent portion, the air passage path is preferably provided above the liquid supply path.

### Advantageous Effects of Invention

According to the present invention, a beverage preparation apparatus simplified in construction which is capable of suppressing increase in temperature of cooling air and suppressing lowering in efficiency in cooling can be provided.

### BRIEF DESCRIPTION OF DRAWINGS

FIG. 1 is an overall perspective view of a beverage preparation apparatus according to a first embodiment.

FIG. 2 is an overall perspective view showing a component of the beverage preparation apparatus shown in FIG. 1.

FIG. 3 is a perspective view of a milling unit provided in the beverage preparation apparatus shown in FIG. 1.

FIG. 4 is an exploded perspective view of the milling unit shown in FIG. 3.

FIG. 5 is a vertical cross-sectional view of the milling unit shown in FIG. 3.

FIG. 6 is a cross-sectional view showing a schematic construction of the beverage preparation apparatus shown in FIG. 1.

FIG. 7 is a diagram showing an internal construction of the beverage preparation apparatus shown in FIG. 1.

FIG. 8 is a perspective view showing a path formation member shown in FIG. 7.

FIG. 9 is a perspective view of the path formation member shown in FIG. 8 viewed from a side of an air outlet and a supply port.

FIG. 10 is an exploded perspective view of the path formation member shown in FIG. 8.

FIG. 11 is a cross-sectional view along the line XI-XI shown in FIG. 8.

FIG. 12 is a diagram showing positional relation between an air passage path and a liquid supply path.

FIG. 13 is a diagram showing a liquid storage tank, the path formation member, and a heater viewed from above.

FIG. 14 is a cross-sectional view along the line XIV-XIV shown in FIG. 12.

FIG. 15 is a perspective cross-sectional view of a beverage preparation apparatus according to a second embodiment.

FIG. 16 is a vertical cross-sectional view of a milling unit according to the second embodiment.

FIG. 17 is a perspective view of a milling unit according to a third embodiment.

FIG. 18 is a vertical cross-sectional view of the milling unit shown in FIG. 17.

FIG. 19 is a perspective view of a milling unit according to a fourth embodiment.

### DESCRIPTION OF EMBODIMENTS

Embodiments of the present invention will be described below in detail with reference to the drawings. In the embodiments shown below, the same or common elements have the same reference numerals allotted in the drawings and description thereof will not be repeated.

### First Embodiment

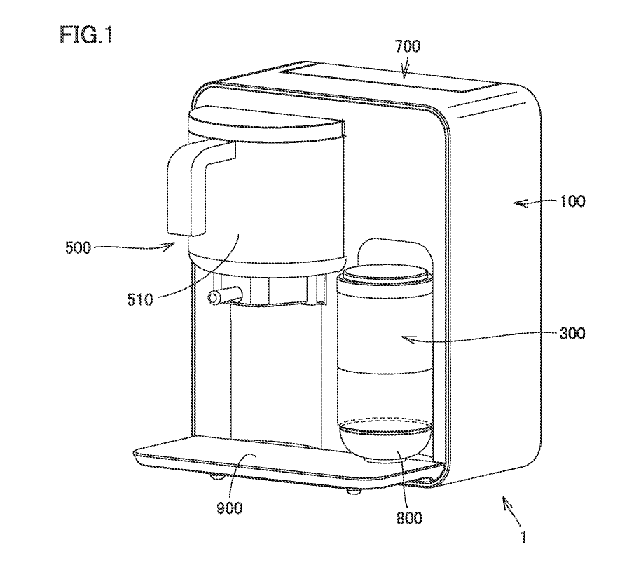

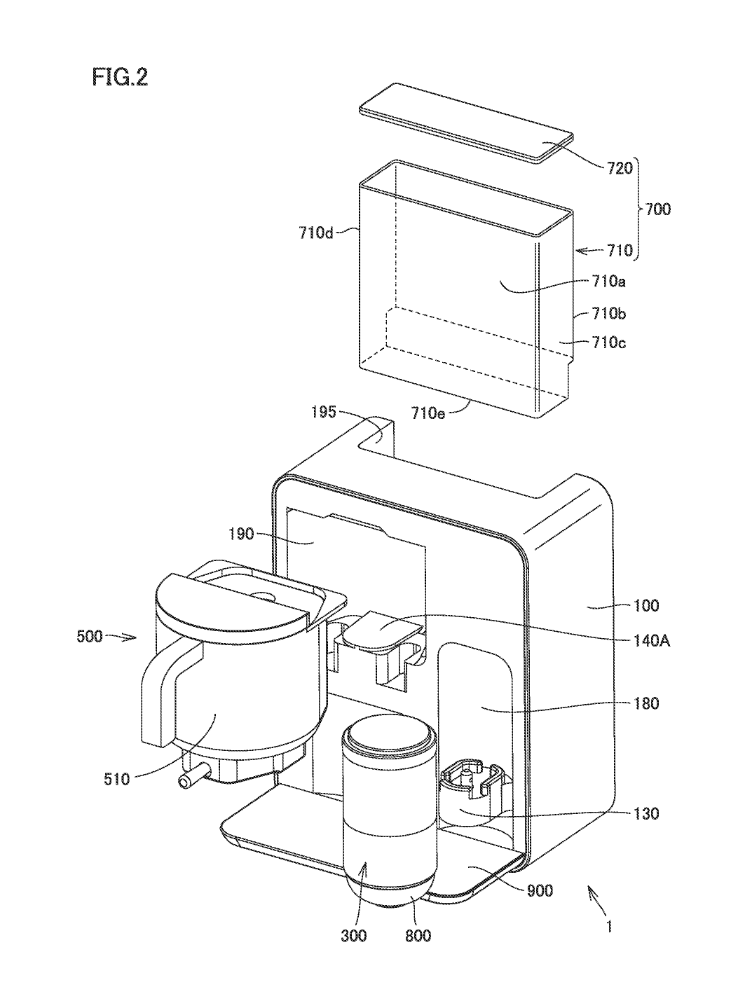

FIG. 1 is an overall perspective view of a beverage preparation apparatus according to the present embodiment. FIG. 2 is an overall perspective view showing a component of the beverage preparation apparatus shown in FIG. 1. A beverage preparation apparatus 1 according to the present embodiment will be described with reference to FIGS. 1 and 2.

As shown in FIGS. 1 and 2, beverage preparation apparatus 1 according to the present embodiment uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100, a milling unit 300, an agitation unit 500, a liquid storage tank 700, a tea leaf powder tray 800, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can hold and move the tray.

(Milling Unit 300)

Milling unit 300 is removably attached to a milling unit attachment portion 180 provided on a front surface side of apparatus main body 100. Milling unit 300 is arranged at a distance from an agitation tank 510 so as not to be superimposed on agitation tank 510 under agitation tank 510 included in agitation unit 500, for example, when viewed from the front.

A milling driving force coupling mechanism 130 is provided in milling unit attachment portion 180 so as to protrude forward and milling unit 300 is removably attached to milling driving force coupling mechanism 130. Milling unit 300 obtains driving force for milling tea leaves representing an object to be grated by being coupled to milling driving force coupling mechanism 130.

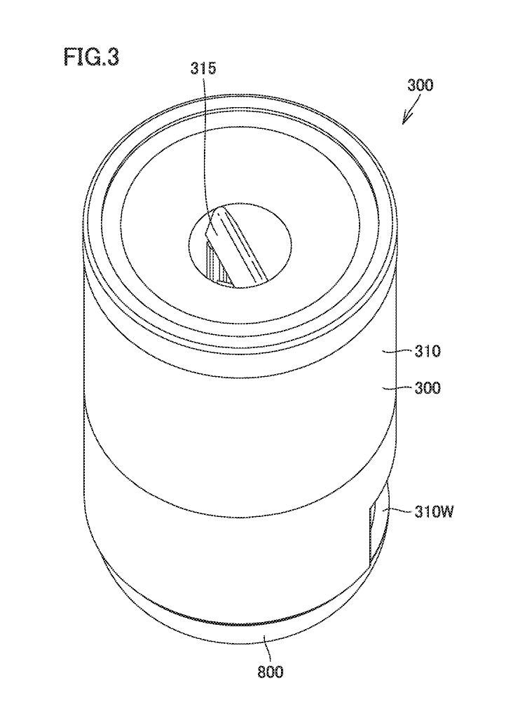

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 3 to 5.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water for supply into agitation tank 510 of agitation unit 500.

Tank main body 710 is substantially in a shape of a box opening upward. Tank main body 710 includes a pair of side surfaces 710c and 710d opposed to each other in a lateral direction, a front surface 710a and a rear surface 710b opposed to each other in a front-rear direction, and a bottom surface 710e connected to lower ends of the pair of side surfaces 710c and 710d, front surface 710a, and rear surface 710b.

(Agitation Unit 500)

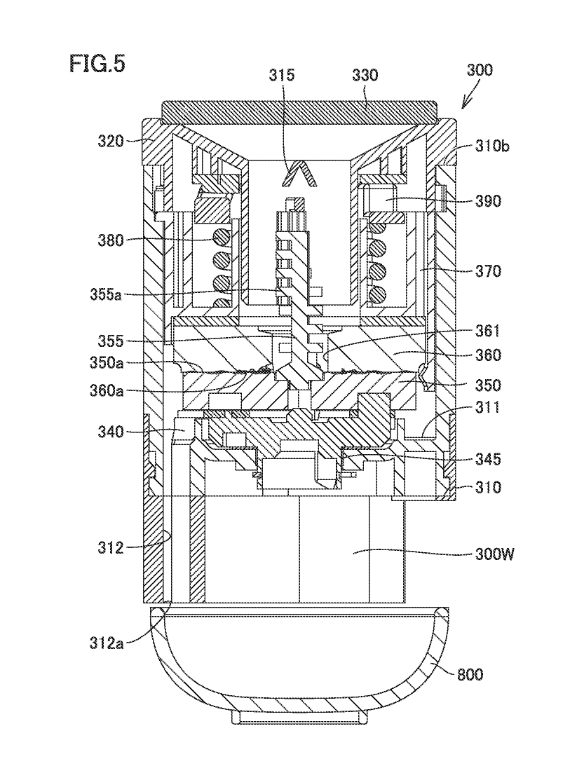

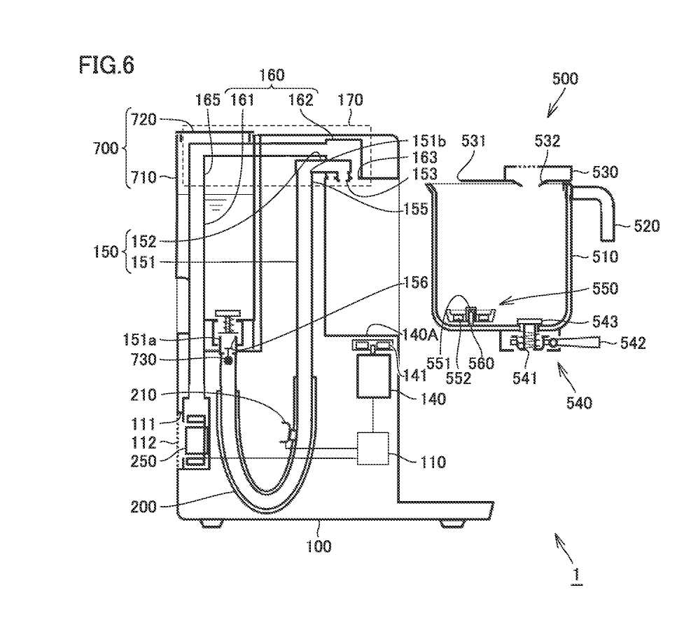

Agitation unit 500 includes agitation tank 510 as a tank to which hot water heated by a heating device 200 (see FIG. 6) which will be described later is supplied and an agitation blade 550 (see FIG. 6) which will be described later. Agitation tank 510 is a container for agitating a liquid and powders. Agitation tank 510 is removably attached to an agitation tank attachment portion 190 provided on the front surface side of apparatus main body 100. Agitation tank 510 is attached to agitation tank attachment portion 190 so as to protrude from apparatus main body 100 in a direction intersecting with a vertical direction. Specifically, agitation tank 510 is attached such that a part of agitation tank 510 protrudes forward from a front surface of apparatus main body 100. A detailed structure of agitation unit 500 will be described later with reference to FIG. 6.

An agitation motor contactless table 140A is provided in agitation tank attachment portion 190. Agitation unit 500 is placed on agitation motor contactless table 140A. Agitation blade 550 provided in agitation unit 500 is rotated by an agitation motor unit 140 (see FIG. 6) and a magnet 141 (see FIG. 6) coupled thereto which are accommodated in apparatus main body 100 so as to be located below agitation motor contactless table 140A.

(Structure of Milling Unit 300)

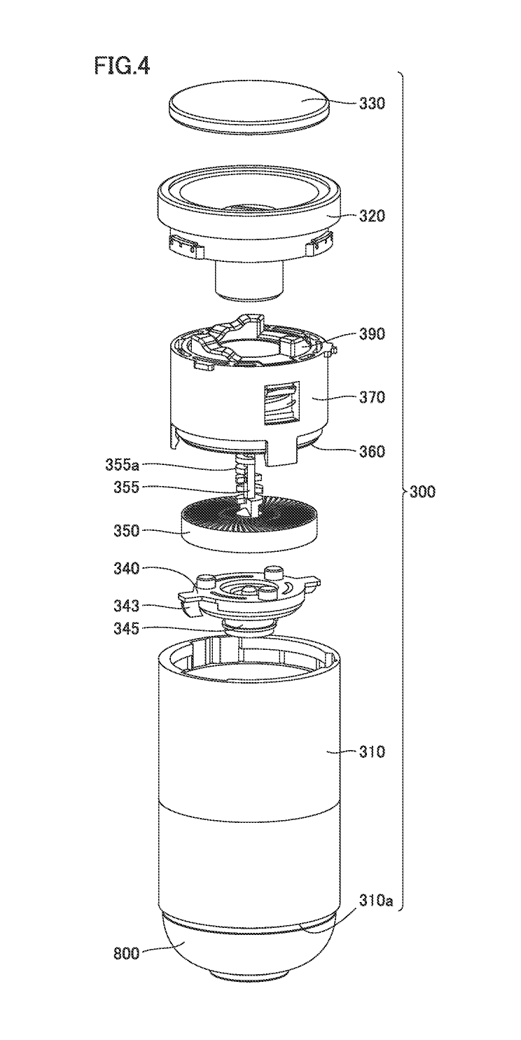

FIG. 3 is a perspective view of the milling unit provided in the beverage preparation apparatus shown in FIG. 1. FIG. 4 is an exploded perspective view of the milling unit shown in FIG. 3. FIG. 5 is a vertical cross-sectional view of the milling unit shown in FIG. 3. A structure of milling unit 300 will be described with reference to FIGS. 3 to 5.

As shown in FIGS. 3 to 5, milling unit 300 has a milling case 310 having a cylindrical shape as a whole and a window 310W for coupling in which milling driving force coupling mechanism 130 is inserted is provided in a side surface below. A discharge outlet 312a is formed at a lowermost end portion of milling case 310 from which powders of tea leaves grated by milling unit 300 are discharged.

A lower mill support portion 340, a lower mill 350, and an upper mill 360 are sequentially provided from below, in the inside of milling case 310. A milling shaft 345 extending downward is provided on a lower surface of lower mill support portion 340 and coupled to milling driving force coupling mechanism 130 to thereby rotationally drive lower mill 350. A powder scraper portion 343 is provided to protrude horizontally at a peripheral edge of lower mill support portion 340.

A core 355 extending upward along a core of a rotation axis is provided in a central portion of lower mill 350. Upper mill 360 is held by an upper mill holding member 370, and a spring 380 and a spring holding member 390 pressing upper mill 360 downward are accommodated in upper mill holding member 370. Core 355 provided in lower mill 350 extends upward to pass through an opening portion 361 provided in the center of upper mill 360. A tip end side of core 355 is located in a hopper 320.

A safety rib 315 in a shape projecting upward is formed above core 355. Safety rib 315 of a prescribed size is provided such that tea leaves can be introduced into hopper 320. Though safety rib 315 has a substantially triangular cross-section at an angle acute in an upward direction, limitation to this shape is not intended.

Hopper 320 for supplying an object to be grated in between upper mill 360 and lower mill 350 is attached on a side of an upper end opening portion 310b of milling case 310. Hopper 320 is in a shape of a funnel.

In grating tea leaves, hopper 320 is preferably covered with a cover portion 330. Thus, after tea leaves are introduced into hopper 320, entry of a foreign matter into milling unit 300 can be prevented. Scattering of grated tea leaves to the outside can be prevented. When tea leaves are to be introduced, cover portion 330 is removed from hopper 320.

Tea leaves introduced into hopper 320 are guided in between upper mill 360 and lower mill 350 as a helical blade 355a rotates with rotation of lower mill 350. Tea leaves guided in between upper mill 360 and lower mill 350 are grated by an upper mill grinding surface 360a of upper mill 360 and a lower mill grinding surface 350a of lower mill 350. Grated tea leaves fall downward in a form of tea leaf powders from a circumference of upper mill 360 and lower mill 350.

Some of fallen tea leaf powders is discharged through a powder discharge path 312 into tea leaf powder tray 800 from discharge outlet 312a. Other fallen tea leaf powders are stored in a storage portion 311. Tea leaf powders in storage portion 311 are transported to powder discharge path 312 and discharged from discharge outlet 312a into tea leaf powder tray 800 as powder scraping portion 343 rotates with rotation of lower mill support portion 340.

(Structure of Agitation Unit 500 and Internal Structure of Beverage Preparation Apparatus 1)

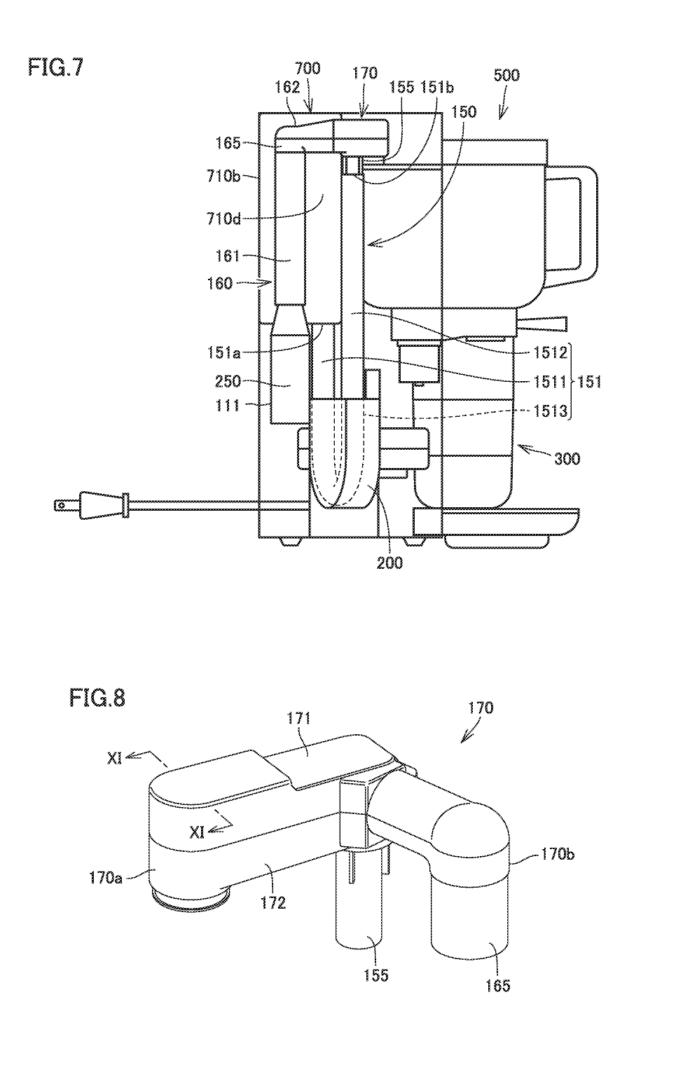

FIG. 6 is a cross-sectional view showing a schematic construction of the beverage preparation apparatus shown in FIG. 1. FIG. 7 is a diagram showing an internal construction of the beverage preparation apparatus shown in FIG. 1. A structure of agitation unit 500 and an internal structure of beverage preparation apparatus 1 will be described with reference to FIGS. 6 and 7.

(Structure of Agitation Unit 500)

As shown in FIG. 6, agitation unit 500 includes agitation tank 510, agitation blade 550, an agitation cover 530, and a discharge port opening and closing mechanism 540. Agitation tank 510 is in a shape of a container having an opening upper surface. Agitation tank 510 accommodates agitation blade 550. Agitation tank 510 includes an exterior holder (not shown) made, for example, of a resin and a thermally insulated tank held by the exterior holder. A grip 520 is provided in agitation tank 510. Grip 520 is formed integrally with the exterior holder with a resin.

Agitation cover 530 is removably attached to an opening portion of agitation tank 510. Agitation cover 530 is provided with a hot water supply inlet 531 through which hot water formed in apparatus main body 100 is poured from a supply nozzle 152 which will be described later and a powder inlet 532 for introducing tea leaf powders grated by milling unit 300. Hot water supply inlet 531 is provided to be able to be opposed to a supply port 153 of supply nozzle 152.

Agitation blade 550 is placed on a bottom portion of agitation tank 510. A rotation shaft 560 extending upward is provided on the bottom portion of agitation tank 510, and a cylindrical core 551 of agitation blade 550 is inserted in this rotation shaft 560.

A magnet 552 is embedded in agitation blade 550. In agitation motor contactless table 140A, magnet 552 embedded in agitation blade 550 and magnet 141 provided on a side of agitation motor unit 140 are magnetically coupled in a contactless state, so that rotational driving force of agitation motor unit 140 is transmitted to agitation blade 550.

Agitation blade 550 can be modified as appropriate so long as an agitation member having an agitation element in an outer circumferential portion is provided. A winding portion made of a wire in a toroidal shape or an impeller can be adopted as the agitation element.

Discharge port opening and closing mechanism 540 includes an opening and closing nozzle 543 which closes a discharge port 541 provided at the bottom portion of agitation tank 510 so as to be able to open and close discharge port 541 and an operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541. Thus, tea in agitation tank 510 is poured into a cup (not shown) placed on placement base 900.

Though an example in which agitation tank 510 is constituted of an exterior holder and a thermally insulated tank in agitation unit 500 described above has been described by way of example, limitation thereto is not intended and the agitation tank may consist of a thermally insulated tank. Instead of a thermally insulated tank, a container which is not thermally insulated but is heat resistant may be employed.

Though an example in which agitation tank 510 is removably attached to apparatus main body 100 in agitation unit 500 described above has been described by way of example, limitation thereto is not intended and the agitation tank may be fixed to apparatus main body 100 so long as powders and hot water can be introduced therein and the inside of agitation tank 510 can be cleaned.

(Internal Structure)

As shown in FIGS. 6 and 7, beverage preparation apparatus 1 includes a control portion 110, a liquid supply path 150, an air passage path 160, heating device 200, a thermistor 210, and a fan 250. Control portion 110 controls operations of heating device 200, fan 250, milling driving force coupling mechanism 130, and agitation motor unit 140 described above.

Liquid supply path 150 is accommodated in apparatus main body 100. Liquid supply path 150 is connected to liquid storage tank 700. Liquid supply path 150 has one end connected to a lower side of liquid storage tank 700 to serve as an introduction port 156 introducing water (liquid) stored in liquid storage tank 700 to the inside and has the other end serving as supply port 153 supplying the liquid to the outside.

Liquid supply path 150 includes a pipe 151 and a supply nozzle 152. Pipe 151 has one end 151a and the other end 151b. Pipe 151 connects supply nozzle 152 and liquid storage tank 700 to each other. Pipe 151 extends once downward from a bottom surface of liquid storage tank 700 and extends upward in a U shape. A check valve 730 is provided on a side of one end 151a of pipe 151. Check valve 730 prevents backflow of a liquid in liquid supply path 150 to liquid storage tank 700.

Supply nozzle 152 has supply port 153 on a tip end side and has a fitting portion 155 on a side of pipe 151. Supply port 153 is provided to be opposed to the bottom portion of agitation tank 510 while agitation tank 510 is attached to agitation tank attachment portion 190.

Fitting portion 155 is provided to removably be fitted to a side of the other end 151b of pipe 151. Fitting portion 155 is in a cylindrical shape. By fitting fitting portion 155 to the side of the other end 151b of pipe 151, pipe 151 is connected to supply nozzle 152.

Heating device 200 is provided in a region intermediate in liquid supply path 150. Heating device 200 heats water in liquid supply path 150. A liquid in liquid supply path 150 is heated by heating device 200 and the liquid is supplied to agitation tank 510 when a pressure in liquid supply path 150 is equal to or higher than a prescribed pressure. For sterilization of water, water is heated to a temperature not lower than 80° C.

Thermistor 210 is provided in the vicinity of heating device 200. Thermistor 210 inputs information on a temperature of heating device 200 to control portion 110. Control portion 110 determines whether or not a temperature of heating device 200 is equal to or higher than a prescribed temperature based on the information on a temperature from thermistor 210.

When water in liquid supply path 150 is totally supplied to agitation tank 510, heat from heating device 200 is no longer transmitted to water and a temperature of heating device 200 increases. Therefore, by determining whether or not a temperature of heating device 200 is equal to or higher than a prescribed temperature, whether or not water in liquid supply path 150 has been supplied to agitation tank 510 is determined. When it is determined that water in liquid supply path 150 has been supplied to agitation tank 510, control portion 110 stops heating by heating device 200.

Air passage path 160 is a path for sending air into agitation tank 510. Air passage path 160 is accommodated in apparatus main body 100. Air passage path 160 includes an air inlet 111 and an air outlet 163. Air inlet 111 is provided on a side of a rear surface of apparatus main body 100. Air inlet 111 may be provided with an air filter 112 catching dust contained in air.

Air inlet 111 is located below air outlet 163. Therefore, when fan 250 is stopped, it becomes difficult for a foreign matter to move from the side of air inlet 111 toward air outlet 163. Thus, entry of a foreign matter into agitation tank 510 can be prevented. When fan 250 is operated, with a path extending upward from below, entry of a foreign matter into agitation tank 510 can be suppressed even though the foreign matter enters air passage path 160.

Air outlet 163 is provided to be opposed to the bottom portion of agitation tank 510 while agitation tank 510 is attached to agitation tank attachment portion 190. Air outlet 163 is provided to surround at least a part of a periphery of supply port 153. In this case, a central axis of air outlet 163 and a central axis of supply port 153 are preferably coaxial.

Air outlet 163 is provided to be able to impinge air at least onto hot water being supplied from supply port 153 into agitation tank 510 (hot water which falls into agitation tank 510) in supply of hot water heated by heating device 200 to agitation tank 510.

Air passage path 160 includes an air duct 162 and an air passage duct 161. Air duct 162 has air outlet 163 described above on a tip end side and has an insertion portion 165 on a side of air passage duct 161. Insertion portion 165 is in a cylindrical shape. By inserting insertion portion 165 into the side of one end 161a of air passage duct 161, air passage duct 161 is connected to air duct 162. Air passage duct 161 connects air duct 162 and air inlet 111 to each other.

Fan 250 is arranged in air passage path 160. Fan 250 sends air taken through air inlet 111 toward air outlet 163. A fan of such a type as a sirocco fan, a propeller fan, or a turbo fan can be adopted as appropriate as fan 250.

Supply nozzle 152 and air duct 162 are formed from a path formation member 170.

(Path Formation Member 170)

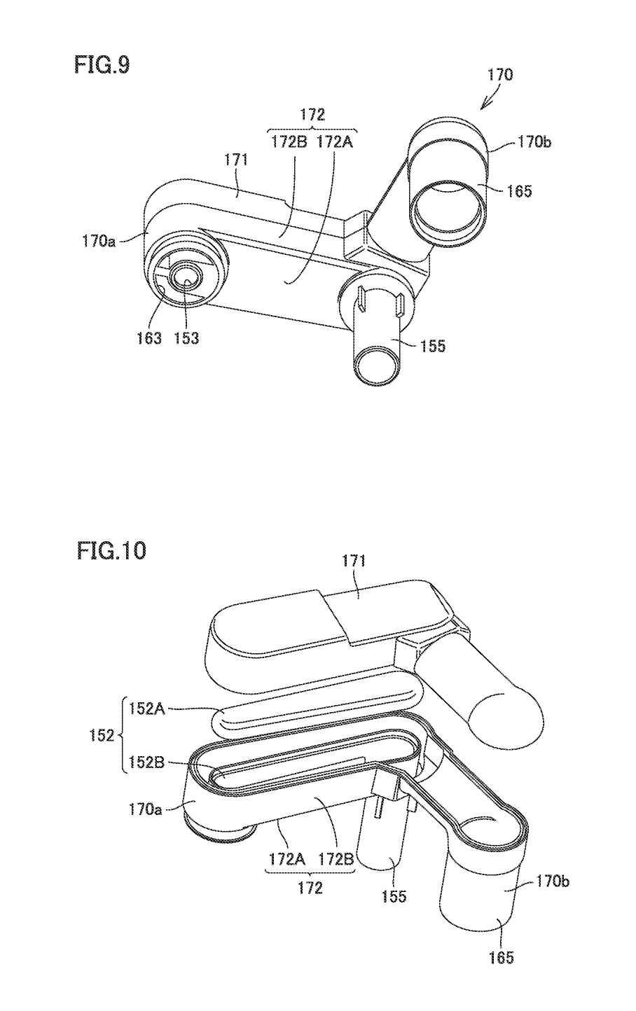

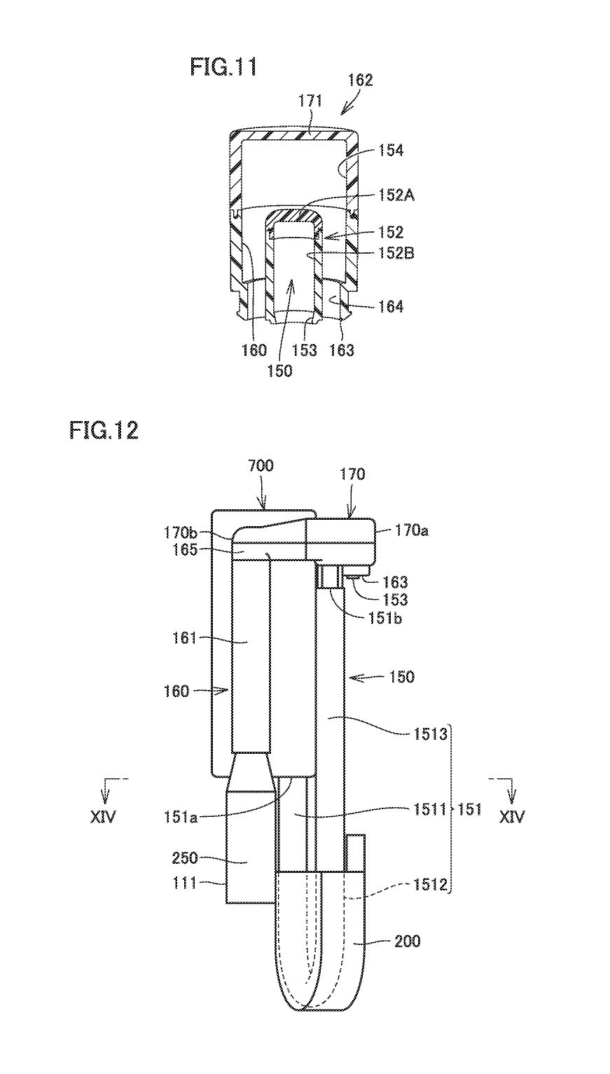

FIG. 8 is a perspective view showing the path formation member shown in FIG. 7. FIG. 9 is a perspective view of the path formation member shown in FIG. 8 viewed from a side of the air outlet and the supply port. FIG. 10 is an exploded perspective view of the path formation member shown in FIG. 8. FIG. 11 is a cross-sectional view along the line XI-XI shown in FIG. 8. Path formation member 170 will be described with reference to FIGS. 8 to 11.

Path formation member 170 has an upper member 171, a lower member 172, and an intermediate member 152A (see FIG. 10). Path formation member 170 is in a substantially L shape. Supply port 153 (see FIG. 9) and air outlet 163 (see FIG. 9) are provided on the side of one end 170a of path formation member 170.

Fitting portion 155 in a cylindrical shape is provided in the vicinity of a bent portion of path formation member 170. Fitting portion 155 is a part of supply nozzle 152 as described above and constitutes a part of liquid supply path 150 for discharging hot water.

Cylindrical insertion portion 165 is provided on the side of the other end 170b of path formation member 170. Insertion portion 165 is a part of air duct 162 as described above and constitutes a part of air passage path 160 for sending air.

The inside of path formation member 170 from the bent portion to one end 170a has a double wall structure. In the inside, a part of air duct 162 (see FIG. 11) is provided to surround supply nozzle 152 (see FIG. 11).

Lower member 172 is provided to open upward. Lower member 172 includes fitting portion 155 and insertion portion 165 described above, a partition portion 152B, a bottom portion 172A, and a peripheral wall portion 172B.

Partition portion 152B is in an oval shape and opens upward. Partition portion 152B is provided to stand from bottom portion 172A in a substantially central portion of lower member 172 extending from the bent portion to one end 170a. Partition portion 152B is provided to connect fitting portion 155 and supply port 153 to each other and to separate supply port 153 and air outlet 163 from each other.

Peripheral wall portion 172B is provided to stand from a peripheral edge of bottom portion 172A. Peripheral wall portion 172B is provided to connect insertion portion 165 and air outlet 163 to each other and to surround partition portion 152B.

Intermediate member 152A is a site closing an opening in an upper surface of partition portion 152B. As intermediate member 152A closes the opening in the upper surface of partition portion 152B, partition portion 152B, intermediate member 152A, and bottom portion 172A define a space communicating with supply port 153 and fitting portion 155. Supply nozzle 152 is thus formed.

Upper member 171 is a site closing an opening in an upper surface of lower member 172. As upper member 171 closes the opening in the upper surface of lower member 172 while supply nozzle 152 is formed, a space separated from the space communicating with supply port 153 and fitting portion 155 described above is provided in path formation member 170. Air duct 162 is thus formed.

The separated space defining a part of air duct 162 is provided to surround the periphery of supply nozzle 152 except for a side of bottom portion 172A. Air passage path 160 is provided to include a portion adjacent to liquid supply path 150 downstream of a region where heating device 200 is provided, and in the adjacent portion, air passage path 160 is provided to include a portion located above liquid supply path 150.

Therefore, before hot water is supplied from supply port 153 into agitation tank 510, hot water which passes through supply nozzle 152 can be cooled by air sent into air duct 162 with partition portion 152B and intermediate member 152A constituting supply nozzle 152 being interposed.

As upper member 171 closes the opening in the upper surface of lower member 172, an air outlet chamber 154 (see FIG. 11) communicating with air outlet 163 on a side of air outlet 163 and changing a direction of air sent by fan 250 toward agitation tank 510 is provided in air passage path 160.

Air outlet chamber 154 is provided to be able to drain from air outlet 163 toward agitation tank 510, condensation water which adheres to air outlet chamber 154 due to entry from air outlet 163 into air outlet chamber 154 and condensation of vapor from hot water supplied into agitation tank 510.

Specifically, for example, an inner wall portion 164 of air duct 162 in a portion defining air outlet 163 is inclined so as to decrease in inner diameter downward. Bottom portion 172A of lower member 172 in a portion extending from the bent portion toward one end 170a is also preferably provided to be inclined downward from the side of the bent portion toward air outlet 163.

Condensation water which adheres to air outlet chamber 154 runs along the inclined surface of bottom portion 172A and the inclined surface of inner wall portion 164 and is drained through air outlet 163. According to such a construction, condensation water can be prevented from moving toward fan 250. Consequently, a portion driving fan 250 can be prevented from short-circuiting.

By employing path formation member 170 constructed as above, not only hot water supplied into agitation tank 510 but also hot water being supplied into agitation tank 510 can be cooled. Therefore, hot water can efficiently be cooled by removing latent heat of evaporation of hot water by positively bringing hot water into direct contact with air in a portion where hot water is at a relatively high temperature.

(Positional Relation Between Air Passage Path and Liquid Supply Path)

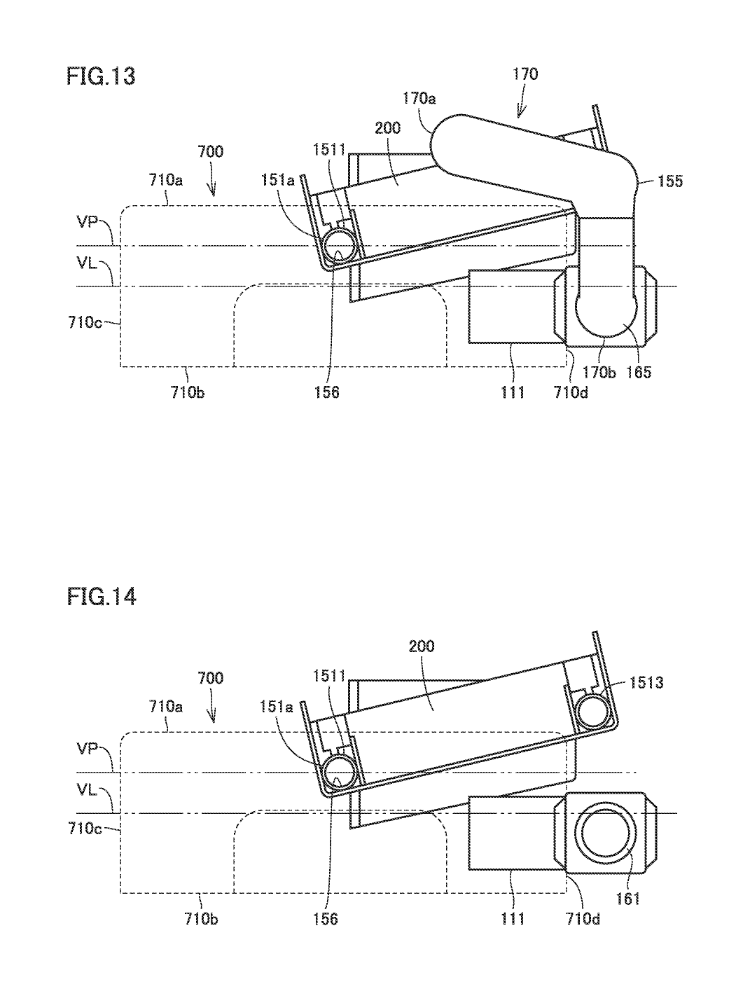

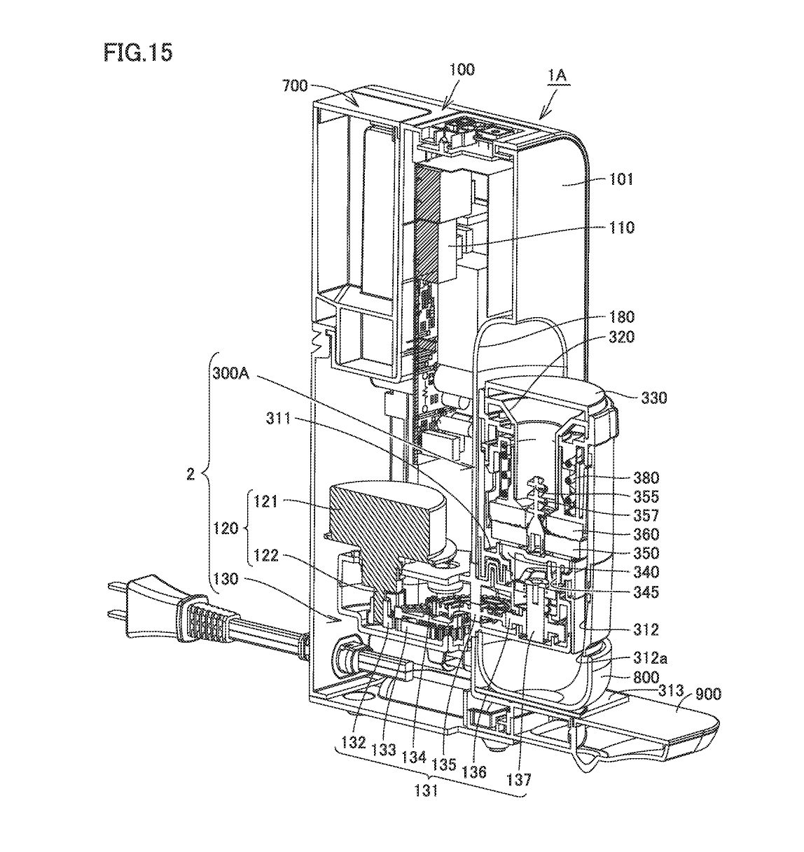

FIG. 12 is a diagram showing positional relation between the air passage path and the liquid supply path. FIG. 13 is a diagram showing the liquid storage tank, the path formation member, and a heater viewed from above. FIG. 14 is a cross-sectional view along the line XIV-XIV shown in FIG. 12. FIGS. 13 and 14 show the liquid storage tank with a dashed line for the sake of convenience. Positional relation between air passage path 160 and liquid supply path 150 will be described with reference to FIGS. 12 to 14.

As shown in FIGS. 12 to 14, introduction port 156 of liquid supply path 150 is provided in bottom surface 710e of liquid storage tank 700. Introduction port 156 is provided, for example, on a front side of a virtual line VL passing laterally through the center of liquid storage tank 700 in the front-rear direction.

Liquid supply path 150 is provided to include a portion which once extends downward from liquid storage tank 700 from introduction port 156 and thereafter extends upward. Specifically, pipe 151 which is a part of liquid supply path 150 has a first portion 1511 extending downward from introduction port 156, a second portion 1512 folded back in a U shape from an end portion downstream of first portion 1511, and a third portion 1513 extending upward from an end portion downstream of second portion 1512.

Heating device 200 is attached around second portion 1512. Second portion 1512 corresponds to a portion of liquid supply path 150 where heating device 200 is provided. Second portion 1512 is provided to include a portion located on a front side of introduction port 156 when viewed from above.

Specifically, an end portion of second portion 1512 located upstream is located below liquid storage tank 700 and an end portion of second portion 1512 located downstream is located on a front side of liquid storage tank 700. Second portion 1512 is provided below liquid storage tank 700.

The end portion of second portion 1512 located downstream is located on the left of liquid storage tank 700 when liquid storage tank 700 is viewed from the front (front side). Second portion 1512 is provided to extend forward as it extends toward the left when viewed from the upper front side of liquid storage tank 700. Second portion 1512 is provided to be inclined forward with respect to a virtual plane VP passing laterally through the center of introduction port 156 when viewed from above.

Third portion 1513 corresponds to a portion of liquid supply path 150 which is located downstream of second portion 1512 where heating device 200 is provided and extends upward. Third portion 1513 is provided to be opposed to a corner portion located on a front left side of liquid storage tank 700 when viewed from the front (front side) of liquid storage tank 700.

Air passage duct 161 corresponds to a portion of air passage path 160 which extends from the lower side toward the upper side along the peripheral surface of liquid storage tank 700. Air passage duct 161 is provided in the vicinity of liquid storage tank 700. Air passage duct 161 is provided to be opposed to left side surface 710d of liquid storage tank 700 when viewed from the front.

Air passage duct 161 is provided to include a portion located on a rear side of virtual line VL which passes laterally through the center of introduction port 156. Air passage duct 161 in its entirety may be provided to be located on the rear side of virtual line VL.

Air inlet 111 is provided on a lower end side of air passage duct 161. Air inlet 111 is provided on the rear side of introduction port 156. Thus, a portion of air passage path 160 located on a side of air inlet 111 is located at a distance from heating device 200 provided in second portion 1512 to extend forward relative to introduction port 156. A portion of air passage path 160 located on the side of air inlet 111 is located in the vicinity of liquid storage tank 700.

As set forth above, in beverage preparation apparatus 1 according to the present embodiment, air passage path 160 is provided to include a portion extending from the lower side toward the upper side along the peripheral surface of liquid storage tank 700. By thus providing air passage path 160, air passage path 160 is located at a distance from heating device 200 and located in the vicinity of liquid storage tank 700.

Air passage path 160 is located at a distance from heating device 200, so that heat from heating device 200 and heat from a liquid heated by heating device 200 are less likely to conduct to air passage path 160 through air in the surroundings. Since air passage path 160 is located in the vicinity of liquid storage tank 700, water stored in liquid storage tank 700 can cool air taken in through air inlet 111.

By using the fan, as compared with such a construction that a heat exchanger or a pump is used to control a temperature of hot water in advance and hot water at a desired temperature is supplied into the agitation tank, hot water can be cooled with a simplified construction.

Consequently, increase in temperature of air (cooling air) taken in through air inlet 111 is suppressed and lowering in efficiency in cooling can be suppressed.

In beverage preparation apparatus 1 according to the present embodiment, air passage path 160 is provided to include a portion which extends from the lower side toward the upper side along the peripheral surface of liquid storage tank 700 on one side in the lateral direction. Liquid supply path 150 is provided to include a portion which once extends downward from liquid storage tank 700 from introduction port 156 and thereafter extends upward. Therefore, heating device 200 is located below liquid storage tank 700 and the center of air inlet 111 of air passage path 160 is located above the upper end of heating device 200, so that air passage path 160 is located at a distance from heating device 200 also in the upward-downward direction.

Consequently, air passage path 160 can be arranged at a further distance from heating device 200. Thus, increase in temperature of air (cooling air) taken in through air inlet 111 is further suppressed and lowering in efficiency in cooling can further be suppressed.

In beverage preparation apparatus 1 according to the present embodiment, the introduction port is provided on the front side of virtual line VL which passes laterally through the center of liquid storage tank 700 in the front-rear direction and a portion of air passage path 160 extending from the lower side toward the upper side along the peripheral surface of liquid storage tank 700 is provided to include a portion located on the rear side of virtual line VL.

Introduction port 156 is thus provided on the front side of liquid storage tank 700 and air passage path 160 is arranged on the rear side of liquid storage tank 700 so that air passage path 160 and heating device 200 can further be spaced apart from each other in the front-rear direction.

Consequently, air passage path 160 can be arranged at a further distance from heating device 200. Therefore, increase in temperature of air (cooling air) taken in through air inlet 111 is further suppressed and lowering in efficiency in cooling can further be suppressed.

Additionally, in beverage preparation apparatus 1 according to the present embodiment, a portion of liquid supply path 150 located downstream of the portion where heating device 200 is provided and extending upward is provided to be opposed to a corner portion of liquid storage tank 700 substantially in a box shape located on one side in the lateral direction.

By providing the portion as such, a space on the front side of liquid storage tank 700 can be ensured while air passage path 160 is distant from heating device 200, and agitation tank 510 great in lateral width can be disposed. With such arrangement that a virtual line connecting the center of liquid supply path 150 at an end portion downstream of the portion where heating device 200 is provided and the center of air passage path 160 in the portion extending from the lower side along the peripheral surface of liquid storage tank 700 to each other passes through liquid storage tank 700, increase in temperature of cooling air can further be suppressed.

In beverage preparation apparatus 1 according to the present embodiment, air passage path 160 is provided to include a portion adjacent to liquid supply path 150 downstream of the region where heating device 200 is provided, and in the adjacent portion, air passage path 160 is provided to include a portion located above liquid supply path 150.

By arranging air passage path 160 adjacent to liquid supply path 150 on a downstream side of heating device 200, heat can efficiently be exchanged. By arranging air passage path 160 low in temperature above and arranging liquid supply path 150 high in temperature below, heat can more efficiently be exchanged. In a portion where heating device 200 is provided and in a portion upstream thereof, an air layer is provided between air passage path 160 and liquid supply path 150, so that increase in temperature of cooling air can be suppressed. On the downstream side of the portion where heating device 200 is provided, no air layer is provided between air passage path 160 and liquid storage tank 150 but they are adjacent to each other, so that heat can efficiently be exchanged.

### Second Embodiment

Various types of beverage preparation apparatuses including a milling unit grating an object to be grated such as tea leaves and a liquid storage tank storing a liquid and preparing a beverage by mixing the liquid and powders obtained by the milling unit have recently be developed. For example, Japanese Patent Laying-Open No. 2005-199242 (PTD 3) discloses such a beverage preparation apparatus.

In a grating apparatus provided in the beverage preparation apparatus disclosed in PTD 3, a power transmission mechanism for rotating a pair of mills relatively to each other by transmitting driving force of a motor is divided into a motor side transmission mechanism and a mill side transmission mechanism. The motor and the motor side transmission mechanism are accommodated in a housing of a driving unit and the pair of mills, the mill side transmission mechanism, and a transportation path for an object to be grated are accommodated in a housing of the milling unit. The driving unit and the milling unit are removably provided such that the motor side transmission mechanism and the mill side transmission mechanism are coupled to each other.

Even when the grating apparatus is disassembled into the driving unit and the milling unit after use, the transportation path for the object to be grated is accommodated in the housing of the milling unit, so that contamination of a floor surface by powders in transportation only of the milling unit can be suppressed.

In the milling unit disclosed in PTD 3, however, a powder discharge port located at an end portion of the transportation path is located above a portion of coupling between the motor side transmission mechanism and the mill side transmission mechanism. In such a case, in pulling a powder collection cup out of a grating unit, powders may be discharged from the powder discharge port and may fall on an upper layer of the driving unit or on the floor surface.

Powders discharged from the powder discharge port may enter the driving unit through the coupling portion through a gap between the grating unit and the driving unit, for example, when the grating apparatus is disassembled into the driving unit and the grating unit. Thus, not only the floor surface and the upper layer of the driving unit but also the inside of the driving unit may be contaminated with powders.

A grating apparatus according to the present embodiment is constructed to prevent drop of powders onto a floor surface and to prevent contamination of a drive mechanism by powders.

(Beverage Preparation Apparatus)

FIG. 15 is a perspective cross-sectional view of a beverage preparation apparatus according to the present embodiment. A beverage preparation apparatus 1A according to the present embodiment will be described with reference to FIG. 15.

As shown in FIG. 15, beverage preparation apparatus 1A according to the present embodiment is different from the beverage preparation apparatus according to the first embodiment in that a milling unit 300A has a powder drop prevention portion 313 on which tea leaf powder tray 800 is placed but substantially the same in other features.

(Grating Apparatus)

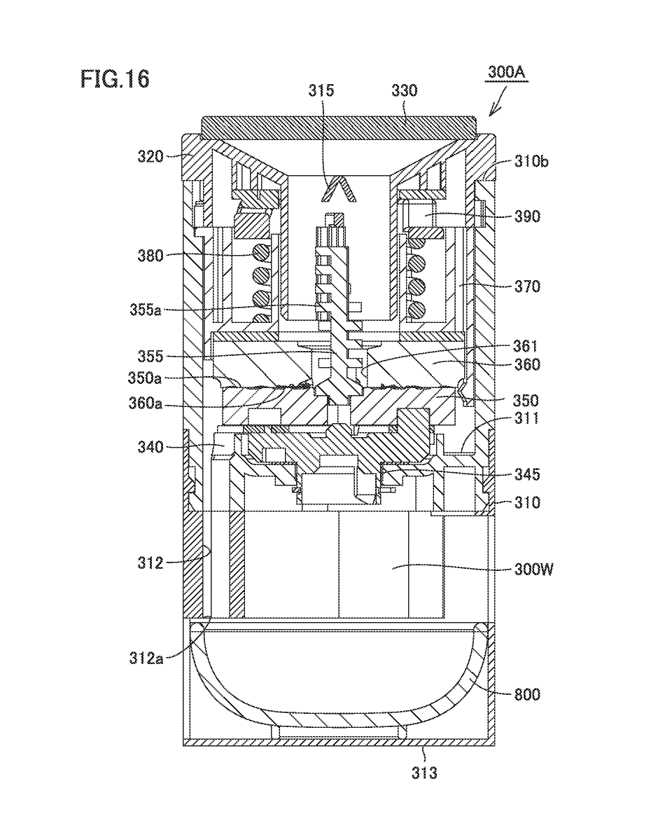

FIG. 16 is a vertical cross-sectional view of the milling unit according to the present embodiment. A grating apparatus 2 according to the present embodiment will be described with reference to FIGS. 15 and 16.

As shown in FIGS. 15 and 16, grating apparatus 2 according to the present embodiment includes milling unit 300A and milling driving force coupling mechanism 130 as a driving unit. Milling driving force coupling mechanism 130 includes a driving portion 120 for generating driving force and a driving force transmission mechanism 131 for transmitting generated driving force.

Driving portion 120 is constituted of a motor 121 and an output shaft 122. Output shaft 122 is connected to driving force transmission mechanism 131.

Driving force transmission mechanism 131 includes a first fixed gear 132 fixed to output shaft 122, a second fixed gear 136 fixed to a rotation axis 137, intermediate gears 133, 134, and 135 mechanically connecting first fixed gear 132 and second fixed gear 136 to each other, and rotation axis 137.

Milling unit 300A includes upper mill 360 and lower mill 350, lower mill support portion 340 as a rotation mechanism, milling case 310 (housing), powder discharge path 312, and tea leaf powder tray 800 as a powder reception portion.

Upper mill 360 and lower mill 350 grate an object to be grated. Lower mill support portion 340 is coupled to rotation axis 137 and rotates lower mill 350.

Specifically, as output shaft 122 rotates, first fixed gear 132 fixed thereto rotates. In coordination with rotation of first fixed gear 132, intermediate gears 133, 134, and 135 rotate, so that second fixed gear 136 also rotates. Thus, rotation axis 137 to which second fixed gear 136 is fixed rotates and lower mill support portion 340 coupled to rotation axis 137 rotates around an axial line. Consequently, lower mill support portion 340 and lower mill 350 integrally rotate and tea leaves are grated between upper mill 360 and lower mill 350.

Milling case 310 accommodates upper mill 360 and lower mill 350 as well as lower mill support portion 340 so as to be able to couple lower mill support portion 340 and rotation axis 137 to each other. Milling case 310 has powder drop prevention portion 313 preventing drop of powders. Powder drop prevention portion 313 is provided to be able to have tea leaf powder tray 800 placed thereon. Powder drop prevention portion 313 is provided to be opposed to discharge outlet 312a of powder discharge path 312. Though powder drop prevention portion 313 is provided to be able to have tea leaf powder tray 800 placed thereon, limitation thereto is not intended and it does not have to have tea leaf powder tray 800 placed thereon. The powder drop prevention portion should only be provided at least in a portion below discharge outlet 312a of powder discharge path 312. Thus, contamination of a floor surface due to drop of powders can be suppressed.

Powder discharge path 312 is provided in milling case 310. Powder discharge path 312 is provided to reach a portion below milling driving force coupling mechanism 130 from at least a part of the circumference of upper mill 360 and lower mill 350 while it is spaced apart from milling driving force coupling mechanism 130 by milling case 310.

Tea leaf powder tray 800 is provided below discharge outlet 312a of powder discharge path 312 and receives powders discharged from discharge outlet 312a.

As set forth above, grating apparatus 2 according to the present embodiment is a grating apparatus obtaining powders by grating an object to be grated, and includes a driving unit (milling driving force coupling mechanism 130) including driving portion 120 for generating driving force and driving force transmission mechanism 131 for transmitting driving force generated by driving portion 120 and milling unit 300A removably attached to the driving unit. Milling unit 300A includes upper mill 360 and lower mill 350 grating an object to be grated, a rotation mechanism (lower mill support portion 340) for rotating upper mill 360 and lower mill 350 relatively to each other, a housing (milling case 310) accommodating upper mill 360, lower mill 350, and the rotation mechanism so as to be able to couple the rotation mechanism and driving force transmission mechanism 131 to each other, powder discharge path 312 provided in the housing, and a powder reception portion (tea leaf powder tray 800) receiving powders discharged from discharge outlet 312a of powder discharge path 312. Powder discharge path 312 is provided to reach a portion below the driving unit from at least a part of the circumference of upper mill 360 and lower mill 350 while it is spaced apart from the driving unit by the housing. The housing has powder drop prevention portion 313 preventing drop of powders. Powder drop prevention portion 313 is provided to be opposed to discharge outlet 312a.

As set forth above, in grating apparatus 2 according to the present embodiment, powder discharge path 312 is provided to reach the portion below the driving unit while it is spaced apart from the driving unit by milling case 310. Thus, powders discharged from discharge outlet 312a of powder discharge path 312 can reliably be prevented from entering the driving unit.

Powder drop prevention portion 313 on which tea leaf powder tray 800 serving as the powder reception portion is placed such that it can be taken out is provided to be opposed to discharge outlet 312a of powder discharge path 312. Thus, even when tea leaf powder tray 800 is removed from powder drop prevention portion 313, powders which have dropped from discharge outlet 312a can be received by powder drop prevention portion 313. Consequently, drop of powders onto a floor surface can be prevented.

### Third Embodiment

Various types of beverage preparation apparatuses including a milling unit grating an object to be grated such as tea leaves and a liquid storage tank storing a liquid and preparing a beverage by mixing the liquid and powders obtained by the milling unit have recently be developed. For example, Japanese Patent Laying-Open No. 2005-199242 (PTD 3) discloses such a beverage preparation apparatus.

The milling unit disclosed in PTD 3 grates an object to be grated introduced into a hopper in a shape of a funnel with a pair of mills. As shown in FIGS. 1 and 2 of PTD 3, the hopper includes a diameter-increasing portion increasing in diameter axially outward and a cylindrical portion provided on a lower end side of the diameter-increasing portion, and includes a linear plate-shaped portion on an upper side (on a side of the diameter-increasing portion) in the cylindrical portion so as to lie across points on an inner circumferential surface of the cylindrical portion along a radial direction.

When the plate-shaped portion is provided in the cylindrical portion as in the milling unit disclosed in PTD 3, however, an area of opening in the cylindrical portion is small, an object to be grated is caught by the plate-shaped portion, and an upper portion of the cylindrical portion may be clogged with the object to be grated.

The milling unit according to the present embodiment is constructed to allow smooth introduction of an object to be grated into the hopper while entry of a finger of a person is prevented.

(Milling Unit)

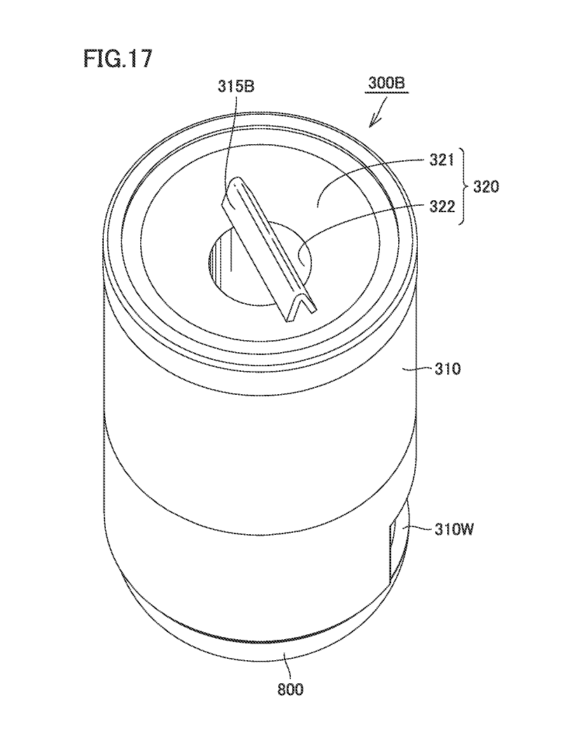

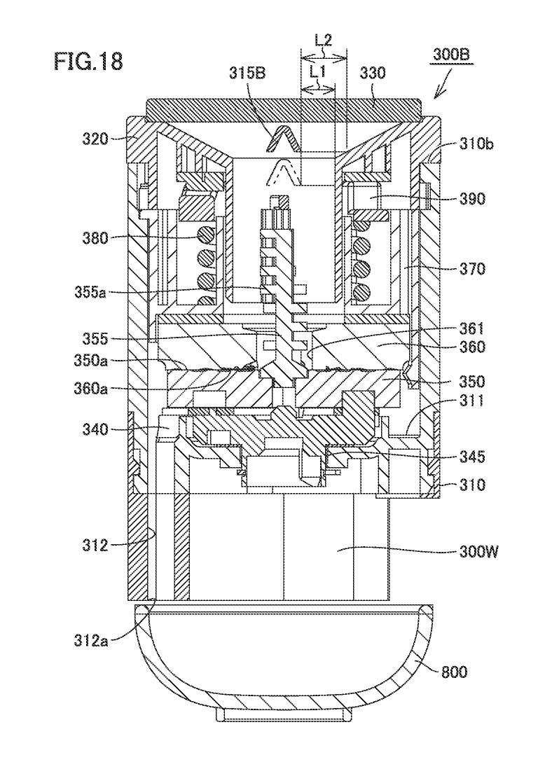

FIG. 17 is a perspective view of the milling unit according to the present embodiment. FIG. 18 is a vertical cross-sectional view of the milling unit shown in FIG. 17. A milling unit 300B according to the present embodiment will be described with reference to FIGS. 17 and 18.

Milling unit 300B according to the present embodiment is different from milling unit 300 according to the first embodiment in position of a safety rib 315B.

In milling unit 300B, hopper 320 has a diameter-increasing portion 321 and a cylindrical portion 322 as in the first embodiment. Diameter-increasing portion 321 is provided such that an inner diameter thereof increases in an upward direction. Cylindrical portion 322 is provided to be connected to a lower end of diameter-increasing portion 321.

Safety rib 315B is provided in diameter-increasing portion 321 as straddling cylindrical portion 322. Safety rib 315B is linearly provided. Though safety rib 315B has a substantially triangular cross-section at an angle acute in an upward direction, limitation to this shape is not intended.

With a substantially triangular cross-section at an acute angle in the upward direction, tea leaves can slide downward along a slope. Thus, tea leaves can readily be introduced into cylindrical portion 322.

As set forth above, milling unit 300B according to the present embodiment is a grating apparatus grating an object to be grated, and includes cylindrical hopper 320 for introduction of an object to be grated from an upper portion, upper mill 360 located below hopper 320 and including upper mill grinding surface 360a and opening portion 361 in a center of upper mill grinding surface 360a, lower mill 350 located below upper mill 360, rotating relatively to upper mill 360, and including lower mill grinding surface 350a abutting on upper mill grinding surface 360a, and core 355 provided in lower mill 350 and extending upward so as to be located in hopper 320 through opening portion 361. Hopper 320 includes diameter-increasing portion 321 increasing in inner diameter in the upward direction and cylindrical portion 322 connected to the lower end of diameter-increasing portion 321. A rib straddling cylindrical portion 322 is provided in diameter-increasing portion 321 so as to allow introduction of an object to be grated into cylindrical portion 322.

By providing safety rib 315B as straddling cylindrical portion 322 instead of providing safety rib 315B in cylindrical portion 322, a distance L2 from the lower end of safety rib 315B to the inner circumferential surface of diameter-increasing portion 321 is greater than a distance L1 from the lower end of the safety rib to the inner circumferential surface of cylindrical portion 322 in an example in which safety rib 315B is provided in cylindrical portion 322.

Thus, tea leaves caught by safety rib 315B can be suppressed and tea leaves can smoothly be introduced into cylindrical portion 322 of hopper 320. By providing safety rib 315B, a finger can be prevented from being entangled in core 355 located in hopper 320.

By providing safety rib 315B above cylindrical portion 322, a volume in cylindrical portion 322 can be increased and an amount of tea leaves which can be introduced into hopper 320 can be increased.

### Fourth Embodiment

(Milling Unit)

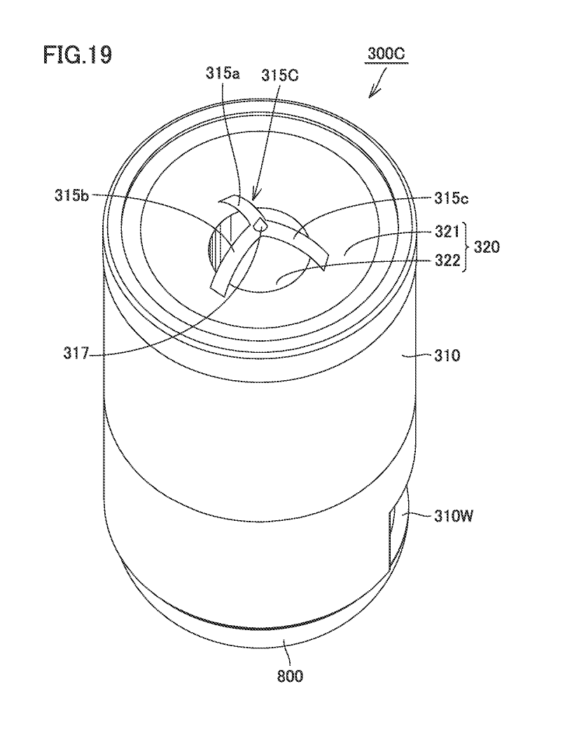

FIG. 19 is a perspective view of a milling unit according to the present embodiment. A milling unit 300C according to the present embodiment will be described with reference to FIG. 19.

Milling unit 300C according to the present embodiment is different from milling unit 300B according to the third embodiment in shape of a safety rib 315C and substantially the same in other features.

Safety rib 315C includes a plurality of arch portions 315a to 315c. One ends of the plurality of arch portions 315a to 315c are connected to the inner circumferential surface of diameter-increasing portion 321. The other ends of the plurality of arch portions 315a to 315c are connected to a protrusion portion 317 located on a substantially central axis of cylindrical portion 322 above cylindrical portion 322. The plurality of arch portions 315a to 315c are circumferentially provided at a substantially uniform pitch.

The plurality of arch portions 315a to 315c are curved upward so as to be closer to the central axis of cylindrical portion 322. The plurality of arch portions 315a to 315c are curved as swelling upward.

Protrusion portion 317 protruding upward is provided at a portion of connection among the plurality of arch portions 315a to 315c. Protrusion portion 317 is in a conical shape.

With such a construction, an area of an opening located on an upper end side of cylindrical portion 322 is greater than in an example in which a safety rib is provided in cylindrical portion 322. Thus, tea leaves can smoothly be introduced into cylindrical portion 322 of hopper 320. By radially providing safety rib 315C from a position above the central axis of core 355 and cylindrical portion 322, a central portion where a finger tends to touch core 355 located in hopper 320 is covered and tea leaves can readily be introduced into cylindrical portion 322 from a portion distant from the center where a finger is less likely to touch core 355.

By providing protrusion portion 317, a user is conscious about necessity to avoid introduction of a finger below by touching protrusion portion 317, which can also lead to prevention of a finger from being entangled in core 355.

Though the embodiments of the present invention have been described above, the embodiments disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

1, 1A beverage preparation apparatus; 2 grating apparatus; 100 apparatus main body; 110 control portion; 111 air inlet; 112 air filter; 120 driving portion; 121 motor; 122 output shaft; 130 milling driving force coupling mechanism; 131 driving force transmission mechanism; 132 first fixed gear; 133, 134, 135 intermediate gear; 136 second fixed gear; 137 rotation axis; 140 agitation motor unit; 140A contactless table; 141 magnet; 150 liquid supply path; 151 pipe; 151a one end; 151b the other end; 152 supply nozzle; 152A intermediate member; 152B partition portion; 153 supply port; 154 air outlet chamber; 155 fitting portion; 156 introduction port; 160 air passage path; 161 air passage duct; 161a one end; 162 air duct; 163 air outlet; 164 inner wall portion; 165 insertion portion; 170 path formation member; 170a one end; 170b the other end; 171 upper member; 172 lower member; 172A bottom portion; 172B peripheral wall portion; 180 milling unit attachment portion; 190 agitation tank attachment portion; 195 liquid storage tank attachment portion; 200 heating device; 210 thermistor; 250 fan; 300, 300A, 300B, 300C milling unit; 310 milling case; 310W window for coupling; 310b upper end opening portion; 311 storage portion; 312 powder discharge path; 312a discharge outlet; 313 powder drop prevention portion; 315, 315B, 315C safety rib; 315a, 315b, 315c arch portion; 317 protrusion portion; 320 hopper; 321 diameter-increasing portion; 322 cylindrical portion; 330 cover portion; 340 lower mill support portion; 343 powder scraping portion; 345 milling shaft; 350 lower mill; 350a lower mill grinding surface; 355 core; 355a helical blade; 360 upper mill; 360a upper mill grinding surface; 361 opening portion; 370 upper mill holding portion; 380 spring; 390 spring holding member; 500 agitation unit; 510 agitation tank; 520 grip; 530 agitation cover; 531 hot water supply inlet; 532 powder inlet; 540 discharge port opening and closing mechanism; 541 discharge port; 542 operation lever; 543 opening and closing nozzle; 550 agitation blade; 551 cylindrical core; 552 magnet; 560 rotation shaft; 700 liquid storage tank; 710 tank main body; 710a front surface; 710b rear surface; 710c, 710d side surface; 710e bottom surface; 720 lid portion; 730 check valve; 800 tea leaf powder tray; 900 placement base; 1511 first portion; 1512 second portion; and 1513 third portion.

1. A beverage preparation apparatus comprising:
a liquid storage tank storing a liquid;
a liquid supply path having one end connected to the liquid storage tank to serve as an introduction port introducing the liquid stored in the liquid storage tank to inside and the other end serving as a supply port supplying the liquid to outside;
a heating device provided in a region intermediate in the liquid supply path, for heating the liquid in the liquid supply path;
a tank to which the liquid heated by the heating device is supplied through the supply port;
an air passage path including an air inlet and an air outlet for sending air into the tank; and
a fan arranged in the air passage path,
the air passage path being provided to include a portion extending from a lower side toward an upper side along a peripheral surface of the liquid storage tank.

2. The beverage preparation apparatus according to claim 1, wherein
the air inlet is located below the air outlet.

3. The beverage preparation apparatus according to claim 1, wherein
the liquid supply path is provided to include a portion which once extends downward from the liquid storage tank from the introduction port and thereafter extends upward,
the heating device is provided below the liquid storage tank, and
the air passage path is located at a distance from the heating device by positioning a center of the air inlet above an upper end of the heating device.

4. The beverage preparation apparatus according to claim 1, wherein
the introduction port is provided on a front side of a virtual line which passes laterally through a center of the liquid supply path in a front-rear direction, and
the portion of the air passage path extending from the lower side toward the upper side along the peripheral surface of the liquid storage tank is provided to include a portion located on a rear side of the virtual line.

5. The beverage preparation apparatus according to claim 1, wherein
the air passage path is provided to include a portion adjacent to the liquid supply path downstream of a region where the heating device is provided, and
in the adjacent portion, the air passage path is provided to include a portion located above the liquid supply path.
